(19) United States
(12) Patent Application Publication
(10) Pub. No.: US 2014/0339825 A1
(43) Pub. Date: Nov. 20, 2014

(54) ELECTRICAL ENERGY GENERATION USING PRESSURIZED GAS FLOWS

(71) Applicant: Pipe-Valves, Inc., Columbus, OH (US)

(72) Inventor: James Leonard, Columbus, OH (US)

(21) Appl. No.: 14/281,450

(22) Filed: May 19, 2014

Related U.S. Application Data
(60) Provisional application No. 61/824,660, filed on May 17, 2013.

(51) Int. Cl. F01D 15/10; H02K 7/18

(52) U.S. Cl. CPC F01D 15/10; H02K 7/1823
USPC 290/43

(57) ABSTRACT

Devices that generate electrical energy from a flow of pressurized gas and methods of use thereof. While in no way limited thereto, exemplary device embodiments are ideally suited for powering electrical energy consuming devices wherever pressurized gas (e.g., air) is available but electrical primary power is not. This includes, for example, control and monitoring equipment, especially wireless devices, in industrial settings and in remote settings such as pipelines.

### CROSS-REFERENCE TO RELATED APPLICATIONS

This application claims the benefit of U.S. Provisional Application No. 61/824,660, filed May 17, 2013, which is hereby incorporated by reference in its entirety.

### TECHNICAL FIELD

Embodiments of the invention are directed to devices that generate electrical energy from a flow of pressurized gas, and to methods of use thereof.

### BACKGROUND

There are various situations and locations where there is a need for electrical energy, but no readily available supply thereof. For example, monitoring equipment, signal transmission equipment, etc., may be frequently placed in remote locations where electric utilities are not available.

While the industries that employ such devices may vary, one exemplary industry of interest herein is the pipeline industry. Pipelines often traverse extremely remote areas where electrical utilities are not present, yet such pipelines may require electrical energy to power various monitoring equipment. For example, pipelines may employ remote, wireless monitoring systems that report on various pipeline conditions such as pressure, flow rate, valve condition/status, etc.

Remote monitoring systems such as those briefly described above require electrical energy for their operation. However, with no ready supply of utility-produced electrical energy, these systems must rely on other sources, such as batteries or supercapacitors. While both battery and supercapacitor technology has advanced considerably, it should be apparent that such a power source is certainly not ideal in remote settings where even periodic replacement or manual recharging can be arduous. Consequently, it should also be apparent that there is a need for an improved system and method for powering remotely located electrical energy consuming devices.

### SUMMARY

Embodiments of the invention are operative to generate electrical energy from a flow of pressurized gas. Generally speaking, exemplary devices of the invention employ flow-induced electrical energy generators to produce an amount of electrical energy that is at least sufficient to power a remotely located electrical energy-consuming device (electrical device). Preferably, exemplary devices of the invention also include electrical energy storage capability in order to store any electrical energy that is produced in excess of the amount required to power a given electrical device.

Embodiments of the invention, while not limited to use therewith, are particularly well-suited to use on pipelines—where there is a readily available source of pressurized gas (e.g., natural gas, compressed air, etc.). In such a setting, an amount of gas flowing through the pipeline may be diverted to such a device, where the gas flow operates an electrical energy producing generator.

Electrical energy generation device embodiments of the invention may include regulators or other elements to control the pressure and flow rate of gas entering the device. Electrical energy generated by such a device may be used in real time to power an electrical device(s) and/or may be stored in an electrical energy storage element(s) such as a battery or supercapacitor for later use. Rectification, conversion and other functions may also be performed, and device functions may be managed by a microcontroller or similar device.

Other aspects and features of the invention will become apparent to those skilled in the art upon review of the following detailed description of exemplary embodiments along with the accompanying drawing figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a schematic representation of the internal componentry of one exemplary embodiment of a device of the invention; and

FIG. 2 is an exemplary exterior rendering of the device of FIG. 1.

### DETAILED DESCRIPTION OF EXEMPLARY EMBODIMENTS

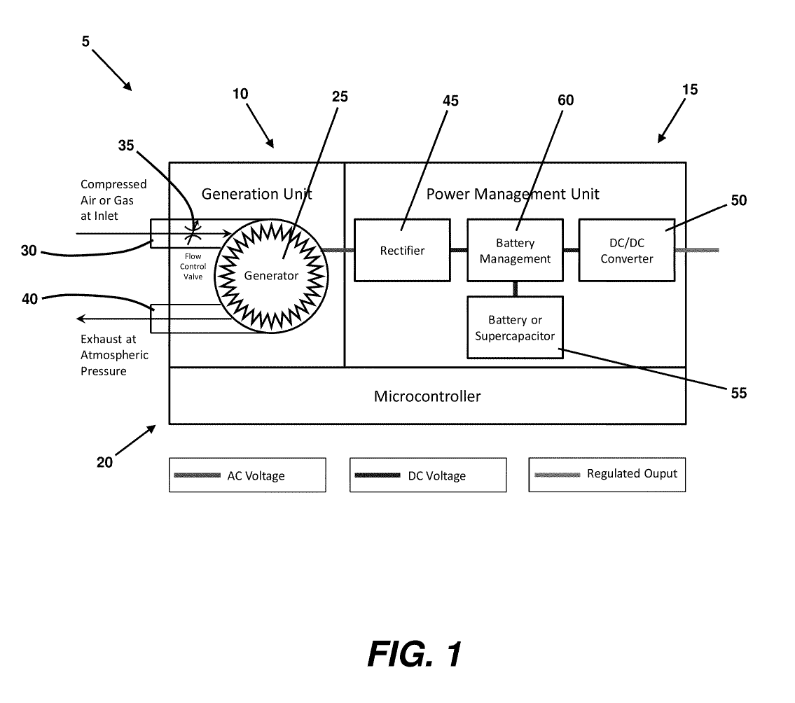

A schematic representation of one exemplary embodiment of an electrical energy generation device 5 (hereinafter generation device for brevity) according to the invention appears in FIG. 1. This particular embodiment of the generation device 5 also includes electrical energy storage functionality, although other embodiments may not.

As shown, the generation device 5 is divided into various sections, including without limitation, a generation unit 10, a power management unit 15, and a microcontroller 20. The generation unit 10 includes a micro-generator 25 that is operative, when subjected to a flow of pressurized gas, to produce electrical energy. The micro-generator 25 may be in the form of, for example and without limitation, a rotational or linear electric generator, such as a turbine-driven or piston-driven micro-generator.

An inlet port 30 is provided to direct a flow of pressurized gas into the micro-generator 25. A flow control valve 35 or similar flow control device may be provided to regulate the pressure and/or flow rate of the gas that enters the micro-generator 25. The inlet flow is preferably regulated to maintain adequate power output to the power management unit 15. Upon passage through the micro-generator 25, the gas flow may be exhausted at atmospheric pressure through a vent port 40. Alternatively, the exhausted gas may be collected in a vessel of some type for possible subsequent use.

In some embodiments, it may be possible for the associated micro-generator to produce direct current (DC) electrical energy. However, in this particular exemplary embodiment, the micro-generator 25 produces alternating current (AC) electrical energy. Consequently, the AC electrical energy from the micro-generator 25 flows to a rectifier 45 of the power management unit 15, where the AC electrical energy is converted to DC electrical energy. A DC/DC converter 50 is also provided to produce a regulated DC output for supply to an electrical device, such as an electrical device described above.

As previously described, this exemplary embodiment of the generation device 5 includes an electrical energy storage device 55 for storing excess electrical energy produced by the micro-generator 25. The electrical energy storage device 55 may be, for example, one or more batteries or supercapacitors, hybrid battery/supercapacitor devices, or combinations thereof. The use of other electrical energy storage devices is also possible, whether such electrical energy storage devices are currently known to those of skill in the art or yet to be discovered. Electrical energy stored in the electrical energy storage device 55 may be used to power an electrical device in communication with the generation device 5 and/or may be used to power the microcontroller 20 of the generation device 5 itself.

The generation device 5 is also shown to include a battery management device 60. The battery management device 60 may be operative to, for example, manage charging and discharging of the electrical energy storage device 55. For example, the battery management device 60 may control battery charging or discharging by controlling how much electrical energy leaving the rectifier 45 goes to the electrical energy storage device 55 versus how much goes to the DC/DC converter 50. Although the terminology battery management device has been used herein generically for purposes of illustration, it is to be understood that the battery management device is a device appropriate for managing the particular type of electrical energy storage device being used—whether the storage device is a battery, a capacitor, or otherwise.

A microcontroller 20 is also provided in this embodiment of the generation device 5. The microcontroller 20 may mange the overall function of the generation device 5, including but not limited to, operation of the flow control valve 35, and control of the power management unit 15. The microcontroller 20 may also, for example, monitor operation and output of the micro-generator 25, the output of the DC/DC converter 50, and the charge level of the electrical energy storage device 55. The microcontroller 20 may also communicate with an electrical device that is connected to the generation device 5. Other microcontroller 20 functions are, of course, also possible.

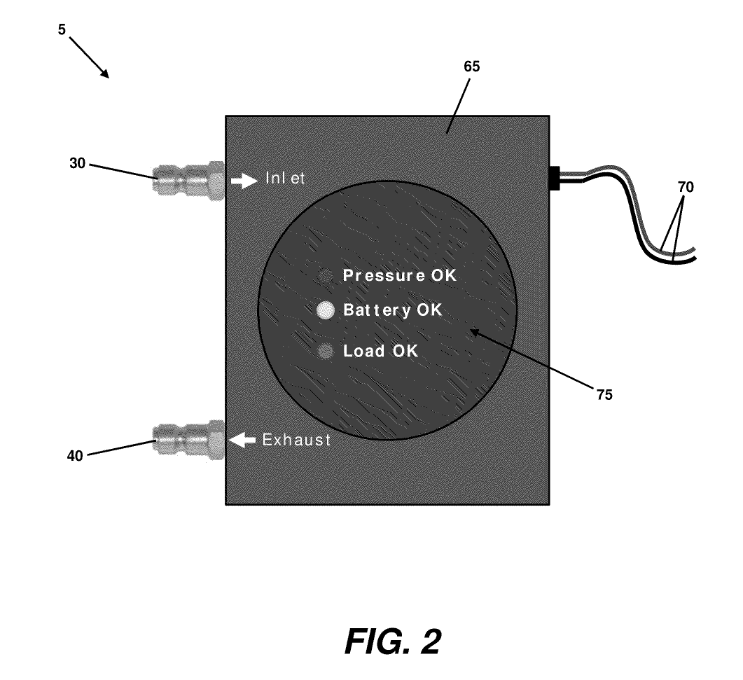

A rendered exemplary exterior of the generation device 5 of FIG. 1 is depicted in FIG. 2. As shown, the generation device 5 includes an enclosure 65 that houses the internal componentry schematically depicted in FIG. 1. The inlet port 30 and the vent port 40 can be seen to pass through the enclosure 65.

A connecting means, generically represented by the wires 70 shown, protrudes from the enclosure 65 for connecting the generation device 5 to an electrical device. The generation device 5 may also include a status indicator 75. In this particular example, the status indicator 75 has indicators relating to the status of the gas pressure entering the generation device 5, the charge condition of the electrical energy storage device 55, and the status of the load presented by the electrical device connected to the generation device 5. Other status indicators are also possible.

While certain exemplary embodiments of the present invention are described in detail above, the scope of the invention is not to be considered limited by such disclosure, and modifications are possible without departing from the spirit of the invention as evidenced by the following claims:

What is claimed is:

1. An electrical energy generation device, comprising:
a generation unit including a micro-generator adapted to produce electrical energy when placed in communication with a flow of pressurized gas;
a power management unit including an electrical energy storage device for receiving and storing electrical energy produced by the micro-generator; and
a microcontroller for managing the functions of the generation unit and the power management unit.

2. The electrical energy generation device of claim 1, wherein the micro-generator is adapted to operate on either pressurized natural gas or compressed air.

3. The electrical energy generation device of claim 1, wherein the micro-generator is a rotational electric generator.

4. The electrical energy generation device of claim 3, wherein the micro-generator is turbine driven.

5. The electrical energy generation device of claim 1, wherein the micro-generator is a linear electric generator.

6. The electrical energy generation device of claim 5, wherein the micro-generator is piston driven.

7. The electrical energy generation device of claim 1, further comprising a flow control device for regulating the pressure and/or flow rate of pressurized gas that enters the micro-generator.

8. The electrical energy generation device of claim 1, further comprising a rectifier that is associated with the power management unit and operative to convert AC electrical energy produced by the micro-generator to DC electrical energy.

9. The electrical energy generation device of claim 1, further comprising a DC/DC converter for producing a regulated DC output.

10. The electrical energy generation device of claim 1, further comprising a battery management device associated with the power management unit, the battery management device operative to manage charging and discharging of the electrical energy storage device.

11. The electrical energy generation device of claim 10, wherein the battery management device is operative to selectively direct electrical energy stored in the electrical energy storage device to an electrical device in communication with the generation device or to the microcontroller of the generation device.

12. The electrical energy generation device of claim 1, further comprising at least one connecting element for connecting the generation device to a separate electrical device.

13. A method of producing electrical energy from a flow of pressurized gas, comprising:
providing an electrical energy generation unit that includes:
a micro-generator adapted to produce electrical energy when placed in communication with a flow of pressurized gas,
a power management unit having an electrical energy storage device for receiving and storing electrical energy produced by the micro-generator, and
a microcontroller for managing the functions of the generation unit and the power management unit;
placing the micro-generator in communication with a flow of pressurized gas; and
selectively storing electrical energy produced by the micro-generator or providing electrical energy produced by the micro-generator to an electrical device.

14. The method of claim 13, wherein the electrical device is the microcontroller of the electrical energy generation unit.

15. The method of claim 13, wherein the electrical device is a device separate from but in electrical communication with the electrical energy generation unit.

16. The method of claim 15, wherein the electrical device is a wireless pipeline monitoring system associated with a pipeline through which passes the flow of pressurized gas.
